(19) United States
(12) Patent Application Publication
(10) Pub. No.: US 2024/0340382 A1
(43) Pub. Date: Oct. 10, 2024

(54) IMAGE FORMING APPARATUS AND IMAGE FORMING APPARATUS SYSTEM

(71) Applicant: SHARP KABUSHIKI KAISHA, Sakai City (JP)

(72) Inventors: Seigo NAKAMURA, Sakai City (JP); Masahiro Kawano, Sakai City (JP); Hirofumi Uchiyama, Sakai City (JP)

(21) Appl. No.: 18/626,783

(22) Filed: Apr. 4, 2024

(30) Foreign Application Priority Data
Apr. 5, 2023 (JP) 2023-061689

(51) Int. Cl. H04N 1/00

(52) U.S. Cl. CPC H04N 1/00639; H04N 1/00411; H04N 1/00413; H04N 1/00466; H04N 2201/0094

(57) ABSTRACT

An image forming apparatus system including an image forming apparatus and an information terminal connected to the image forming apparatus, in which the image forming apparatus includes a scoring section which forms a crease on a sheet of paper, a folder which folds the sheet of paper, and an image former which forms an image on the sheet of paper, and the information terminal comprises a display which displays a folding setting screen to make a setting on a folding mode of the sheet of paper, wherein in the information terminal, when an instruction is given by an operator to execute saddle stitch processing for the sheet of paper, the display displays the folding setting screen, and on the folding setting screen, a setting display to set a number of folding places and a distance between the folding places is presented.

### CROSS-REFERENCE TO RELATED APPLICATION

The present application claims priority from Japanese Application JP2023-061689, the content to which is hereby incorporated by reference into this application.

### BACKGROUND OF THE INVENTION

### 1. Field of the Invention

The present disclosure relates to an image forming apparatus and an image forming apparatus system capable of forming an image and performing saddle stitch processing.

### 2. Description of the Related Art

Conventionally, there have been known image forming apparatuses that not only form (print) an image onto a sheet of paper, but also perform saddle stitch processing by stacking a plurality of sheets of paper on which images have been formed. Such an image forming apparatus includes not only an image former which forms an image on a sheet of paper, but also a scoring section which performs scoring on the paper, and a folder which folds a paper bundle, which is in a state in which a plurality of sheets of paper that have been scored by the scoring section are stacked over one another, in half at a central part of the sheets of paper, and the image forming apparatus performs the saddle stitch processing for the sheets of paper on which images have been formed.

However, in the image forming apparatus as described above, when scoring and folding are performed after an image has been formed on a sheet of paper, in other words, after toner has been fused and fixed onto the paper, a problem such as the image being damaged may occur due to peeling of the toner, for example. In order to avoid such a problem, for example, in conventional image forming systems, scoring and folding are performed on a sheet of paper before an image is formed on the sheet of paper, and the image is formed on the sheet of paper after execution of the scoring and the folding. In this way, peeling of the toner fused and fixed onto the sheet of paper is prevented.

### SUMMARY OF THE INVENTION

However, since an image is formed on a folded sheet of paper in a conventional image forming apparatus, the toner is to be fused and fixed onto the paper in a state in which a folding mark is formed on the paper. Since the folding mark formed on the paper is recessed, there is a possibility that an image may not be correctly formed. That is, a problem such as the image formed on the folding mark being warped or distorted may occur.

Hence, what is requested is a technique whereby it is possible to suppress, without scoring and folding a sheet of paper before forming an image on the sheet of paper, damage being caused to the image in saddle stitch processing.

The present disclosure has been conceived in view of the above-described circumstances, and an object of the present disclosure is to provide an image forming apparatus and an image forming apparatus system capable of performing saddle stitch processing, and suppressing damage to an image formed on a sheet of paper.

An image forming apparatus system according to one aspect of the present disclosure is provided with an image forming apparatus and an information terminal connected to the image forming apparatus, in which the image forming apparatus includes a scoring section which forms a crease on a sheet of paper, a folder which folds the sheet of paper, and an image former which forms an image on the sheet of paper, and the information terminal includes a display which displays a folding setting screen to make a setting on a folding mode of the sheet of paper. The image forming apparatus system is characterized in that, in the information terminal, when an instruction is given by an operator to execute saddle stitch processing for the sheet of paper, the display displays the folding setting screen, and on the folding setting screen, a setting display to set the number of folding places and a distance between the folding places is presented.

Thus, the operator can set the number of folding places and the distance between the folding places while looking at the folding setting screen displayed on the display. Consequently, the sheet of paper can be folded at an optimum position when the saddle stitch processing is to be performed for the sheet of paper. Therefore, it is possible to prevent the sheet of paper from being forcibly folded, and a problem, such as damage being caused to the image formed on the sheet of paper, can be suppressed.

Further, in the information terminal in the above-described image forming apparatus system, when an instruction is given by the operator to execute the saddle stitch processing for the sheets of paper, the scoring section may execute scoring to form a crease on at least one sheet of paper among the sheets of paper instructed to be folded.

Thus, since the scoring processing is performed for at least a part of the sheets of paper to be subjected to the saddle stitch processing in accordance with the situation, the scoring processing is not performed for a sheet of paper which does not need to undergo the scoring processing, and so the saddle stitch processing can be performed efficiently.

Further, in the above-described image forming apparatus system, the information terminal may be provided with a folding mode decision section which decides on the number of folding places and the distance between the creases on the basis of the number of sheets of paper for which the saddle stitch processing is instructed, and the scoring section may form the crease on the sheet of paper on the basis of the number of folding places and the distance between the folding places decided by the folding mode decision section, and the folder may fold the sheet of paper.

Thus, the operator is not required to set the number of folding places and the distance between the folding places while looking at the folding setting screen displayed on the display, and the sheet of paper can be folded at an optimum position. Therefore, a burden on the operator is reduced, and work can be efficiently performed. In addition, it is possible to prevent the sheet of paper from being forcibly folded, and a problem, such as damage being caused to the image formed on the sheet of paper, can be suppressed.

Further, in the above-described image forming apparatus system, the folding mode decision section may decide on the number of folding places and the distance between the creases also in consideration of the thickness of the sheet of paper for which an instruction is given to execute the saddle stitch processing.

Thus, since the thickness of the sheet of paper is also taken into consideration in setting the number of folding places and the distance between the folding places, the sheet of paper can be folded at a more optimum position. Therefore, it is possible to prevent the sheet of paper from being forcibly folded, and a problem, such as damage being caused to the image formed on the sheet of paper, can be suppressed.

Further, in the above-described image forming apparatus system, the number of folding places and the distance between the creases decided by the folding mode decision section may be changeable by the operator.

Thus, since the operator can modify the number of folding places and the distance between the creases decided by the folding mode decision section, the folding mode can be changed according to the operator's judgement in accordance with the state of the sheet of paper. Therefore, it is possible to prevent the sheet of paper from being forcibly folded, and a problem, such as damage being caused to the image formed on the sheet of paper, can be suppressed.

An image forming apparatus according to one aspect of the present disclosure is provided with a scoring section which forms a crease on a sheet of paper, a folder which folds the sheet of paper, and an image former which forms an image on the sheet of paper, in which the image forming apparatus includes a display which displays a folding setting screen to make a setting on a folding mode of the sheet of paper. The image forming apparatus is characterized in that, when an instruction is given by an operator to execute saddle stitch processing for the sheet of paper, the display displays the folding setting screen, and on the folding setting screen, a setting display to set the number of folding places and a distance between the folding places is presented.

Thus, the operator can set the number of folding places and the distance between the folding places while looking at the folding setting screen displayed on the display. Consequently, the sheet of paper can be folded at an optimum position when the saddle stitch processing is to be performed for the sheet of paper. Therefore, it is possible to prevent the sheet of paper from being forcibly folded, and a problem, such as damage being caused to the image formed on the sheet of paper, can be suppressed.

According to the present disclosure, it is possible to provide an image forming apparatus and an image forming apparatus system capable of performing saddle stitch processing and suppressing damage to an image formed on a sheet of paper.

### BRIEF DESCRIPTION OF THE DRAWINGS

FIG. 1 is a front view illustrating an external schematic configuration of an image forming apparatus system according to a first embodiment of the present disclosure.

FIG. 2 is a block diagram schematically illustrating a configuration of control in the image forming apparatus system according to the first embodiment of the present disclosure.

FIG. 3 is a first diagram illustrating an example of a display image on a display of an information terminal according to the first embodiment of the present disclosure.

FIG. 4 is a second diagram illustrating an example of a display image on the display of the information terminal according to the first embodiment of the present disclosure.

FIG. 5 is a third diagram illustrating an example of a display image on the display of the information terminal according to the first embodiment of the present disclosure.

FIG. 6 is a first enlarged view of a setting display, which is a part of the display image on the display of the information terminal according to the first embodiment of the present disclosure.

FIG. 7 is a second enlarged view of a setting display, which is a part of the display image on the display of the information terminal according to the first embodiment of the present disclosure.

FIG. 8 is a first diagram illustrating a table indicating data regarding the number of folds and a folding width of a sheet of paper in the information terminal according to the first embodiment of the present disclosure.

FIG. 9 is a second diagram illustrating a table indicating data regarding the number of folds and a folding width of a sheet of paper in the information terminal according to the first embodiment of the present disclosure.

FIG. 10 is a third diagram illustrating a table indicating data regarding the number of folds and a folding width of a sheet of paper in the information terminal according to the first embodiment of the present disclosure.

FIG. 11 is a flowchart illustrating an example of a control operation of the information terminal according to the first embodiment of the present disclosure.

FIG. 12 is a front view illustrating an external schematic configuration of an image forming apparatus according to a second embodiment of the present disclosure.

### DETAILED DESCRIPTION OF THE INVENTION

Embodiments according to the present disclosure will be described below with reference to the accompanying drawings.

### First Embodiment

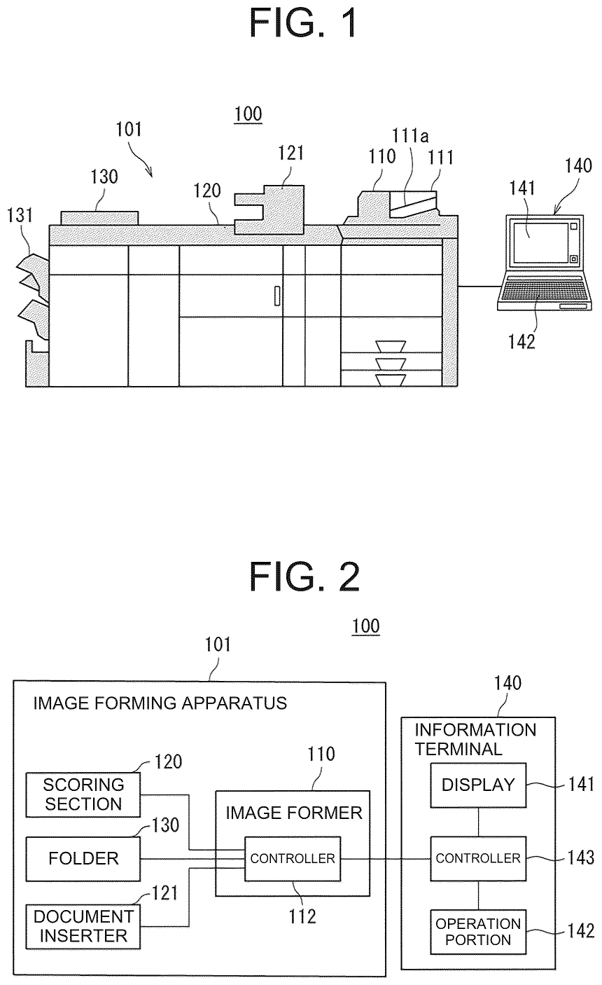

With reference to the drawings, a configuration of an image forming apparatus system according to a first embodiment of the present disclosure will be described. FIG. 1 is a front view illustrating an external schematic configuration of an image forming apparatus system according to the first embodiment of the present disclosure.

As illustrated in FIG. 1, an image forming apparatus system 100 is provided with an image forming apparatus 101 and an information terminal 140 connected to the image forming apparatus 101. The image forming apparatus 101 can form an image on a sheet of paper and perform saddle stitch processing for the sheet of paper on which the image has been formed. That is, in order to perform the saddle stitch processing, scoring processing can be performed for the sheet of paper, and sheets of paper subjected to the scoring processing can be stacked over one another and folded. Further, in the image forming apparatus 101, it is also possible to perform the saddle stitch processing by using a sheet of paper on which no image has been formed as a cover sheet.

The image forming apparatus 101 is provided with an image former 110, a scoring section 120, a document inserter 121, and a folder 130.

The image former 110 has the function of forming an image on a sheet of paper, and is, for example, a multifunction peripheral (MFP). Note that the MFP is a multifunction peripheral having the functions of a copier, a printer, a facsimile machine, a scanner, and the like. The image former 110 is provided with a document feeder 111 including a document placement tray 111a at an upper part of the image former 110. When a document is set on the document placement tray 111a, the document is automatically sent by the document feeder 111, so that an image of the document is read, and image data of the read document can be generated. The image data can be formed on a sheet of paper. Further, it is also possible to form an image on a sheet of paper on the basis of image data transmitted from the information terminal 140 which will be described later. The sheet of paper on which the image has been formed by the image former 110 is sent to the scoring section 120 disposed adjacent to the image former 110.

The scoring section 120 has the function of performing the scoring processing to be carried out before folding processing, in order to facilitate the folding of the sheet of paper subjected to the saddle stitch processing. The scoring section 120 also has a punching function, etc., of punching holes in paper. The scoring processing is processing of forming a crease line in advance at a position where a sheet of paper is folded by the folding processing. For example, such a configuration that a scoring tooth is lowered from an upper surface of a sheet of paper to sandwich the sheet of paper between the scoring tooth and a receiving table installed on a lower surface of the sheet of paper, thereby forming a crease on the sheet of paper may be adopted.

In the document inserter 121, a sheet of paper, which serves as a cover sheet when saddle stitch processing is performed, is inserted. Normally, sheets of paper other than the cover sheet are sent to the scoring section 120 after an image has been formed by the image former 110. However, the cover sheet is different from the other sheets of paper in many aspects, such as that, unlike the other types of paper, paper on which an image has already been formed is used as the paper for the cover sheet. Thus, since an image is formed under a condition different from those of the other sheets of paper, the cover sheet is sent to the scoring section 120 via the document inserter 121 separately from the other sheets of paper to perform the scoring processing. The sheets of paper including the cover sheet for which the scoring processing has been performed are sent to the folder 130.

The folder 130 has the function of performing the folding processing of stacking, over one another, a plurality of sheets of paper for which the scoring processing has been performed by the scoring section 120, and folding the sheets of paper along the scored places. The folder 130 is, for example, a saddle finisher. The saddle finisher has a stapling function of performing stapling, a saddle folding function of folding sheets of paper (i.e., folding processing) and thereafter discharging the folded sheets of paper, and a bookbinding function such as the saddle stitch processing, or the like. The folder 130 is provided with a paper discharge tray 131, and discharges the sheet of paper subjected to the folding processing and the like to the paper discharge tray 131.

As the information terminal 140 is operated by an operator, the information terminal 140 instructs the image forming apparatus 101 to execute a function such as the saddle stitch processing by the image former 110, the scoring section 120, the document inserter 121, and the folder 130. The information terminal 140 is, for example, a personal computer. The information terminal 140 is provided with a display 141 which displays an image, and an operation portion 142, such as a keyboard and a mouse, for the operator to operate the information terminal 140. Note that the display 141 may be a touch panel display. In that case, since the display 141 is operated by performing an operation such as tapping a button displayed on the display 141, the display 141 includes the operation portion 142.

The operator operates the operation portion 142 while looking at an image displayed on the display 141 of the information terminal 140. For example, the operator can use the operation portion 142 to instruct that printing of predetermined image data should be performed on a plurality of sheets of paper and saddle stitch processing should be performed for these sheets of paper by folding the paper. In addition, as for the cover sheet which serves as the outer side when the sheets of paper are saddle-stitched, the paper quality of the cover sheet is different from that of the sheets of paper to be printed. For this reason, the cover sheet may be prepared separately from the sheets of paper to be printed. The cover sheet may be set in the document inserter 121.

Further, as the operator operates the information terminal 140, in the image forming apparatus 101, the saddle stitch processing is performed for the sheets of paper. Specifically, an image is formed (printed) on one or more sheets of paper in the image former 110, and the sheet of paper on which the image has been formed is creased in the scoring section 120. Note that the cover sheet is also sent to a main body of the scoring section 120 from the document inserter 121, and a crease line is formed thereon. It is not necessary to form a crease line on all of the sheets of paper. It suffices that if all of the sheets of paper which are to be saddle-stitched in the subsequent folding processing can be processed without any problem. In other words, the scoring processing may be performed for only a specific sheet of paper. That is, it is sufficient if the scoring processing is performed for at least one sheet of paper among the sheets of paper (including the cover sheet) to be subjected to the saddle stitch processing. For example, the scoring processing may be performed for only the cover sheet to form a crease line thereon. If the crease line is formed on only the cover sheet to be positioned on the outer side when the saddle stitch processing is performed, the sheets of paper as a whole can be easily folded in the subsequent folding processing.

After the scoring processing, in the folder 130, the sheets of paper are stacked over one another and are folded such that the cover sheet comes on the outer side, and the saddle stitch processing is performed. After the saddle stitch processing has been performed, the sheets of paper are discharged to the paper discharge tray 131.

Next, with reference to the drawings, a configuration of control in the image forming apparatus system 100 will be described. FIG. 2 is a block diagram schematically illustrating the configuration of control in the image forming apparatus system according to the first embodiment of the present disclosure.

As illustrated in FIG. 2, the image former 110 is further provided with a controller 112 which manages the overall control of the image former 110. As described above, the image former 110 has the functions of a copier, a printer, a facsimile machine, a scanner, and the like, and the controller 112 manages the operation of each of these functions. That is, the controller 112 also controls the operations of the respective members of the image former 110, such as the document feeder 111 (see FIG. 1). Further, the controller 112 manages control of the operation of not only the image former 110, but also the scoring section 120, the document inserter 121, and the folder 130. Furthermore, the controller 112 also controls the operations of the members of the scoring section 120, the document inserter 121, and the folder 130, respectively.

The controller 112 includes, for example, a microcomputer, such as a central processing unit (CPU), and a storage device, such as a read-only memory (ROM), a random-access memory (RAM), and a data rewritable nonvolatile memory. A control program stored in advance in the ROM, which is the storage device, is loaded onto the RAM, whereby the operation of each unit is controlled. Also, the RAM of the storage device provides a work area for work of the controller 112 and an area as an image memory for storing the image data.

Also, the information terminal 140 is further provided with a controller 143. The controller 143 comprehensively controls the operation of the information terminal 140 as a whole, and makes various kinds of determination. For example, the controller 143 transmits, on the basis of an instruction from an operator that is input from the operation portion 142, an operation instruction to the image former 110. As the image former 110 is instructed to perform the saddle stitch processing by the information terminal 140, the image former 110 performs the saddle stitch processing on the sheet of paper in cooperation with the scoring section 120, the document inserter 121, and the folder 130. Further, the controller 143 also controls a display on the display 141. Further, though details will be described later, the controller 143 also functions as a folding mode decision section which decides on a folding mode, such as the number of folding places and a crease-to-crease distance in the saddle stitch processing.

The controller 143 includes, for example, a microcomputer, such as a CPU, and a storage device, such as a ROM, a RAM, and a data rewritable nonvolatile memory. The ROM, which is the storage device, stores, for example, data for making a decision on the folding mode on the basis of the number of folding places, the crease-to-crease distance, and the like, described above.

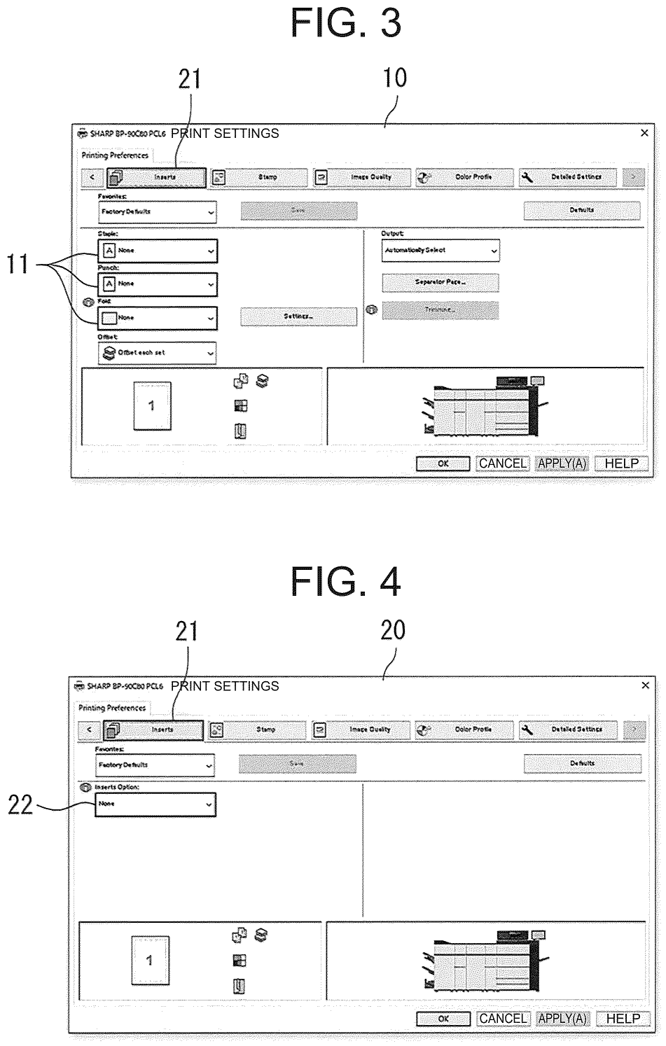

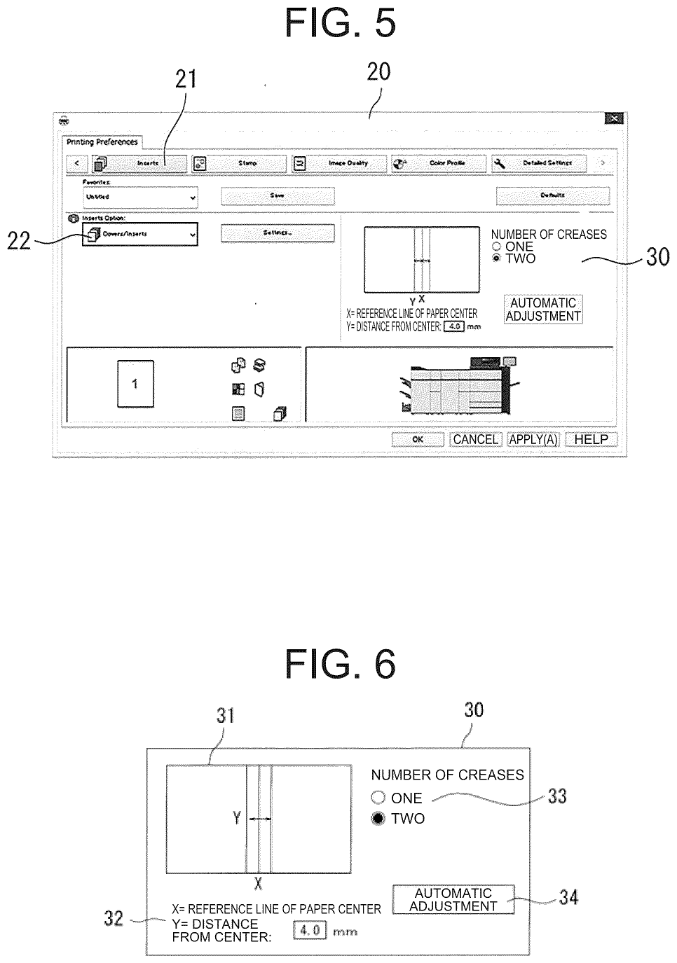

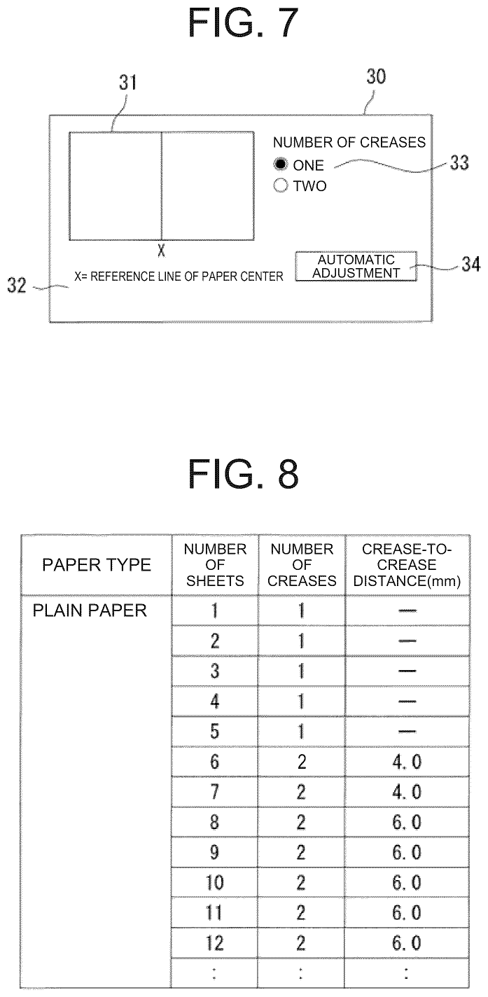

Next, with reference to the drawings, a procedure for executing, while referring to the display on the display 141 of the information terminal 140, the saddle stitch processing by operating the image forming apparatus system 100 (the information terminal 140) will be described. FIG. 3 is a first diagram illustrating an example of a display image on the display of the information terminal according to the first embodiment of the present disclosure. FIG. 4 is a second diagram illustrating an example of a display image on the display of the information terminal according to the first embodiment of the present disclosure. FIG. 5 is a third diagram illustrating an example of a display image on the display of the information terminal according to the first embodiment of the present disclosure. FIG. 6 is a first enlarged view of a setting display, which is a part of the display image on the display of the information terminal according to the first embodiment of the present disclosure. FIG. 7 is a second enlarged view of a setting display, which is a part of the display image on the display of the information terminal according to the first embodiment of the present disclosure.

In a case where sheets of paper are to be bound, for example, the operator causes the image forming apparatus 101 of the image forming apparatus system 100 to execute the saddle stitch processing. First, for the cover sheet which is to be positioned on the outer side when the sheets of paper are bound, a sheet of paper on which an image has already been formed is often used, unlike the other sheets of paper. The cover sheet is set in the document inserter 121. The operator uses the information terminal 140 and specifies the image data applied for printing on a sheet of paper which is to come on the inner side relative to the cover sheet. Further, the operator operates the operation portion 142 to input execution of the saddle stitch processing. As a result, a saddle stitch processing instruction screen 10 as illustrated in FIG. 3 is displayed on the display 141. On the saddle stitch processing instruction screen 10, saddle stitch content setting buttons 11 are displayed. Specifically, the saddle stitch content setting button 11 is a button to make the setting of whether to use each of the scoring section 120 and the folder 130 (stapling function) in the saddle stitch processing. The operator selects operation of the scoring section 120 and the folder 130 (stapling function) in addition to the image former 110 by using the operation portion 142, such as a mouse, to move a cursor onto the saddle stitch content setting button 11 of the saddle stitch processing instruction screen 10 and clicking on the saddle stitch content setting button 11. Specifically, the operator selects the above operation by performing a pull-down menu operation on the saddle stitch content setting button 11.

On the saddle stitch processing instruction screen 10, after selecting the saddle stitch content setting button 11, operating an insertion button 21 (see FIG. 3) that is displayed causes a folding setting screen 20 as illustrated in FIG. 4 to be displayed on the display 141. On the folding setting screen 20, when “Insert Cover Sheet” is selected by performing a pull-down menu operation on an insertion option button 22, a setting display 30 is additionally displayed on the right side of the folding setting screen 20 as illustrated in FIG. 5. The operator can set the number of creases (i.e., the number of folding places) and the crease-to-crease distance (i.e., a distance between the folding places) while viewing the setting display 30 and imagining an actual state in which the sheets of paper are folded regarding the saddle stitch processing of the paper. Note that the number of creases to be selected is either one or two, and when one is selected as the crease, the position of the center line of a sheet of paper is assumed as a crease place so that the sheet of paper can be folded in a bilaterally symmetrical way. Further, when two is selected as the crease, the positions of two places which are bilaterally symmetrical with respect to the position of the center line of the sheet of paper are assumed as the crease places.

As illustrated in FIG. 6, when the operator operates the operation portion 142 to select the number of creases as two at a crease number setter 33 of the setting display 30, a folding form display portion 31 presents a display which schematically indicates the positions of the creases with respect to the sheet of paper. The operator operates the operation portion 142 to set a distance between the creases (i.e., a distance between the folding places) at a crease-to-crease distance setter 32. In FIG. 6, as an example, a case where a distance between the creases is set to 4.0 mm is indicated. Further, by causing the distance between the creases to be changed at the crease-to-crease distance setter 32, the positions of the creases at the folding form display portion 31 are also changed accordingly. Since the setting of two creases, in addition to one crease, has been enabled as the number of creases, the saddle stitch processing can be performed without performing forcible folding. When the number of creases is two, the sheet of paper is folded to be U-shaped.

In addition, as illustrated in FIG. 7, when the operator operates the operation portion 142 to select the number of creases as one at the crease number setter 33 of the setting display 30, a display, which schematically indicates the state in which the number of creases is one, is presented in the folding form display portion 31. In this case, there is no need to set a distance between the creases, and it is acceptable not to present a display for setting the distance between the creases.

As illustrated in FIGS. 6 and 7, the setting display 30 includes an automatic adjustment setting button 34. When the operator selects the automatic adjustment setting button 34 displayed on the setting display 30 by using the operation portion 142, the operator is not required to set the number of creases and the crease-to-crease distance. That is, preferable values of the number of creases and the crease-to-crease distance are decided and set by the controller 143. The controller 143 stores therein data for making a decision on preferable values of the number of creases and the crease-to-crease distance, and the number of creases and the crease-to-crease distance are decided on the basis of the aforementioned data. Further, the number of creases and the crease-to-crease distance that have been decided are displayed on the crease number setter 33 and the crease-to-crease distance setter 32. Details of the data will be described later. In addition, even in a case where the automatic adjustment setting button 34 is operated, and preferable values of the number of creases and the crease-to-crease distance are decided by the controller 143 and are set to the crease number setter 33 and the crease-to-crease distance setter 32, the number of creases and the crease-to-crease distance set to the crease number setter 33 and the crease-to-crease distance setter 32 can be changed by the operator by operating the operation portion 142.

When the setting of the number of creases and the crease-to-crease distance is made by the operator, or the decision and the setting of the number of creases and the crease-to-crease distance are made by the automatic adjustment, and the operator operates the information terminal 140 to instruct that printing should be executed, the image former 110 forms a predetermined image on a sheet of paper and the scoring processing is performed on the sheet of paper on which the image has been formed and the cover sheet set in the document inserter 121. It is acceptable if the scoring processing is performed for only the cover sheet and not performed for the other sheets of paper. As long as the crease lines are formed on the cover sheet, even if no crease lines are formed on the other sheets of paper, the cover sheet and the other sheets of paper can be stacked over one another and easily folded. That is, if the scoring processing is performed for only the cover sheet so that the crease lines are formed on only the cover sheet in advance, a problem in the folding processing is less likely to occur. In this way, by not forming a crease line on sheets of paper other than the cover sheet, a step of the scoring processing can be simplified, so that the time can be reduced and the efficiency is improved.

When the scoring processing is finished, the folder 130 folds the cover sheet and the other sheets of paper along the crease lines in a state in which the cover sheet and the other sheets of paper are stacked over one another. As a result, the saddle stitch processing is completed. In a case where a setting is made by the operator to execute stapling or the like, the stapling or the like is executed. The sheets of paper for which the saddle stitch processing is executed are discharged to the paper discharge tray 131.

As described above, according to the image forming apparatus system 100 of the present Embodiment 1, when saddle stitch processing is to be performed for sheets of paper for the purpose of bookbinding or the like, an operator can set the number of creases to be selected from one or two, and when the number of creases is selected to be two, the operator can set the crease-to-crease distance. As a result, the operator can set the number of creases and the crease-to-crease distance to preferable values on the basis of the state of the image formed on the sheet of paper, the number of sheets of paper to be saddle-stitched, the thickness of the sheet of paper, and the like. Thus, the saddle stitch processing is performed in such a way that the number of creases and the crease-to-crease distance are as set by the operator. Therefore, it is possible to suppress a problem, which is that a sheet of paper is forcibly folded and so an image formed on the sheet of paper is damaged. In addition, since the operator can set the number of creases and the crease-to-crease distance while confirming the state of a crease position and the like by viewing the folding setting screen 20 that is displayed on the display 141, the operation is facilitated and a burden on the operator can be reduced.

Now, data for making a decision on preferable values of the number of creases and the crease-to-crease distance will be described with reference to the drawings.

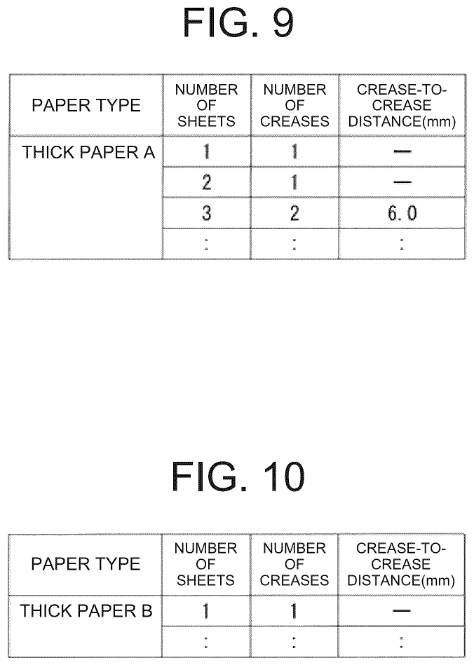

FIG. 8 is a first diagram illustrating a table indicating data regarding the number of folds and a folding width of a sheet of paper in the information terminal according to the first embodiment of the present disclosure. FIG. 9 is a second diagram illustrating a table indicating data regarding the number of folds and a folding width of a sheet of paper in the information terminal according to the first embodiment of the present disclosure. FIG. 10 is a third diagram illustrating a table indicating data regarding the number of folds and a folding width of a sheet of paper in the information terminal according to the first embodiment of the present disclosure.

The table illustrated in FIG. 8 shows the relationship between the number of sheets of paper for which the saddle stitch processing is to be performed and the number of creases and the crease-to-crease distance of the case in which the type of paper corresponds to plain paper. The thickness of the plain paper is 120 μm. That is, when one sheet of plain paper is to be subjected to saddle stitch processing, the number of creases may be set to one, as indicated in FIG. 8. Since the number of creases is one, there exists no crease-to-crease distance. As regards the plain paper, when saddle stitch processing is to be performed by stacking sheets of paper from two to five, the number of creases may be set to one.

Further, when six or seven sheets of the plain paper are stacked over one another to perform the saddle stitch processing, as indicated in FIG. 8, the number of creases may be set to two, and the crease-to-crease distance may be set to 4.0 mm. Furthermore, when eight to twelve sheets of the plain paper are stacked over one another to perform the saddle stitch processing, as indicated in FIG. 8, the number of creases may be set to two, and a distance between the creases may be set to 6.0 mm.

The table illustrated in FIG. 9 shows the relationship between the number of sheets of paper for which the saddle stitch processing is to be performed and the number of creases and the crease-to-crease distance of the case in which the type of paper corresponds to thick paper A, which is thicker than the plain paper. The thickness of the thick paper A is 300 μm. That is, when saddle stitch processing is to be performed for one sheet of thick paper A or two sheets of stacked thick paper A, the number of creases may be set to one, as indicated in FIG. 9. Since the number of creases is one, there exists no crease-to-crease distance. Further, when three sheets of the thick paper A are stacked over one another to perform the saddle stitch processing, as indicated in FIG. 9, the number of creases may be set to two, and a distance between the creases may be set to 6.0 mm.

The table illustrated in FIG. 10 shows the relationship between the number of sheets of paper for which the saddle stitch processing is to be performed and the number of creases and the crease-to-crease distance of the case in which the type of paper corresponds to thick paper B, which is thicker than the plain paper and the thick paper A. The thickness of the thick paper B is 450 μm. That is, when saddle stitch processing is to be performed for one sheet of thick paper B, the number of creases may be set to one, as indicated in FIG. 10. Since the number of creases is one, there exists no crease-to-crease distance. Further, when two or more sheets of the thick paper B are stacked over one another, it becomes difficult to perform the folding processing.

The controller 143 of the information terminal 140 stores the data of the contents illustrated in FIGS. 8 to 10. As described above, when the operator selects the automatic adjustment setting button 34 displayed on the setting display 30 by using the operation portion 142, the number of creases and the crease-to-crease distance are decided and set on the basis of the above data. Note that the number of creases and the crease-to-crease distance may be decided also in consideration of factors other than the number of sheets of paper and the thickness of the paper. Also, there may be a case where the thickness is different in only the cover sheet as compared to the other sheets of paper. However, in that case, the number of creases and the crease-to-crease distance may be decided in consideration of both the thickness of the cover sheet and the thickness of the other sheets of paper, and the controller 143 may be made to store data for such a purpose in advance.

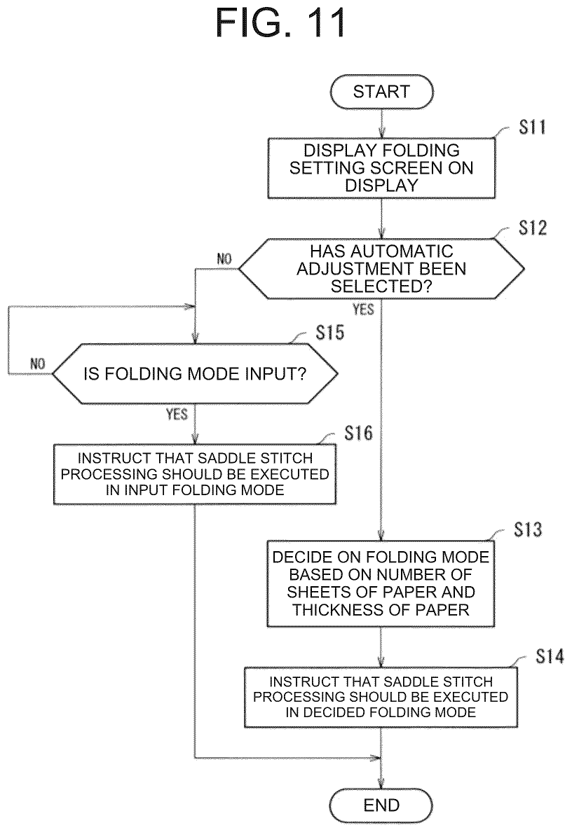

Next, with reference to the drawings, an example of a control operation in the information terminal 140 of the image forming apparatus system 100 will be described. FIG. 11 is a flowchart illustrating an example of the control operation of the information terminal according to the first embodiment of the present disclosure.

As described above, as the operator, after selecting the saddle stitch content setting button 11 on the saddle stitch processing instruction screen 10 (see FIG. 3) that is displayed on the display 141, operates the insertion button 21 and further operates the insertion option button 22 (see FIG. 4), the display on the display 141 is changed to be the folding setting screen 20 (see FIG. 5) including the setting display 30 (see FIGS. 6 and 7).

That is, as indicated in FIG. 11, in accordance with an instruction from the controller 143, the display 141 displays the folding setting screen 20 (see FIG. 5) including the setting display 30 (step S11). Then, it is determined whether or not the automatic adjustment setting button 34 has been selected on the setting display 30 included in the folding setting screen 20 (step S12). If the automatic adjustment setting button 34 has been selected, in other words, if the operator has selected the automatic adjustment setting button 34 of the setting display 30 (YES in step S12), a folding mode corresponding to the number of creases and the crease-to-crease distance is decided on the basis of the number of sheets of paper and the thickness of the paper for which the saddle stitch processing is to be performed (step S13). Then, the decided folding mode is set, and an instruction is given to the image forming apparatus 101 to execute the saddle stitch processing in the folding mode that has been set (step S14). Specifically, the image former 110 is instructed to execute the saddle stitch processing. Then, the controller 143 ends the processing. In this way, the image former 110 controls the scoring section 120, the document inserter 121, and the folder 130 to execute the saddle stitch processing.

If the automatic adjustment setting button 34 has not been selected, which corresponds to the case of NO in step S12, that is, if the operator has not selected the automatic adjustment setting button 34 of the setting display 30, it is determined whether the folding mode has been input by the operator (step S15). That is, it is determined whether the number of creases has been input to the crease number setter 33 (see FIGS. 6 and 7), and when the number of creases that has been input is two, it is determined whether the crease-to-crease distance has been input to the crease-to-crease distance setter 32. If the folding mode has not been input by the operator (NO in step S15), a process of step S15 is repeated again. Meanwhile, if the folding mode has been input by the operator (YES in step S15), an instruction is given to the image forming apparatus 101 to execute the saddle stitch processing in the input folding mode (step S16). Specifically, the image former 110 is instructed to execute the saddle stitch processing. Then, the controller 143 ends the processing. In this way, the image former 110 controls the scoring section 120, the document inserter 121, and the folder 130 to execute the saddle stitch processing.

The image forming apparatus system 100 according to the first embodiment has been described above. As described above, according to the image forming apparatus system 100 of the first embodiment, the number of folding places and a distance between the folding places can be set while looking at the folding setting screen 20 displayed on the display 141. Therefore, it is possible to fold sheets of paper at an optimum position when the saddle stitch processing is to be performed for the sheets of paper. Therefore, it is possible to prevent the sheets of paper from being forcibly folded, and prevent an image formed on the paper from being damaged.

Also, according to the image forming apparatus system 100, by the selection of the automatic adjustment setting button 34, the image forming apparatus system 100 decides on and sets the number of folding places and the distance between the folding places on the basis of the number of sheets paper, the thickness of the paper, and the like. Therefore, a burden on the operator is reduced, and the sheets of paper can be folded at the optimum position when the saddle stitch processing is to be performed for the sheets of paper.

### Second Embodiment

An image forming apparatus according to a second embodiment of the present disclosure will be described. As the above first embodiment, the image forming apparatus system 100 which is provided with the image forming apparatus 101 and the information terminal 140 has been described. Meanwhile, the second embodiment has a configuration in which an image forming apparatus 102 includes an information terminal 150, which is a tablet personal computer. In other words, the image forming apparatus 102 is provided with the information terminal 150.

In the second embodiment, description of the points that are similar to those of the first embodiment will be omitted. Also, in the drawings, the same reference numerals are assigned to members that are the same as those of the first embodiment.

With reference to the drawing, a configuration of an image forming apparatus according to the second embodiment of the present disclosure will be described.

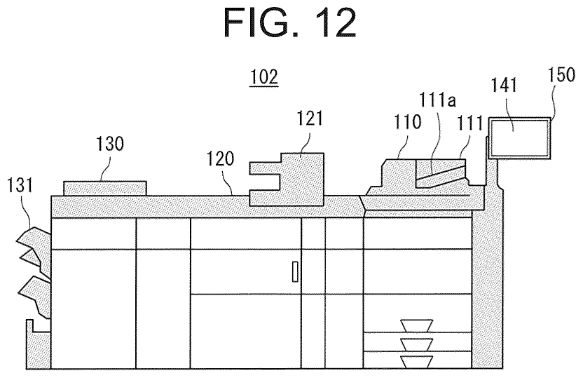

FIG. 12 is a front view illustrating an external schematic configuration of the image forming apparatus according to the second embodiment of the present disclosure.

As illustrated in FIG. 12, the image forming apparatus 102 is provided with an image former 110, a scoring section 120, a document inserter 121, a folder 130, and the information terminal 150. Further, since the information terminal 150 is a tablet-type terminal, a display 141 is a touch panel display. The image forming apparatus 102 can be operated by performing an operation such as tapping a button displayed on the display 141. Consequently, it becomes possible to save space for installing the image forming apparatus 102.

Note that the information terminal 150 has the same configuration as that of the information terminal 140 of the first embodiment except that the information terminal 150 is a tablet-type terminal. In response to an operation on the information terminal 150, an instruction is given to the image former 110 by a controller 143 of the information terminal 150, and the image former 110, the scoring section 120, the document inserter 121, and the folder 130 are operated, whereby the saddle stitch processing can be executed.

In addition, the image forming apparatus 102 may be configured to include a display device instead of the information terminal 150, and a controller 112 of the image former 110 may be made to perform the control that has been performed by the controller 143 of the information terminal 150.

The present disclosure is not limited to the embodiments described above but may be implemented in various other forms. Accordingly, the embodiments as described are merely examples in all respects and should not be interpreted restrictively. The scope of the present disclosure is as indicated by the appended claims and is not bound in any way by the text of the specification. Moreover, all modifications and variations that come within the equivalent range of the scope of the claims are within the scope of the present disclosure.

Moreover, each functional block or various features of the apparatus used in the embodiments described above may be implemented in or executed by electric circuitry, such as a single integrated circuit or a plurality of integrated circuits. The electric circuitry designed to execute the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may be a microprocessor or, alternatively, a conventional processor, a controller, a microcontroller, or a state machine. The electric circuitry described above may be constituted by a digital circuit or by an analog circuit. Moreover, when a technology for forming an integrated circuit which could substitute for the current integrated circuits emerges as a result of the progress of the semiconductor technology, it is possible to use a new integrated circuit based on such technology for one or more aspects of the present disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus system comprising an image forming apparatus and an information terminal connected to the image forming apparatus, in which
the image forming apparatus comprises a scoring section which forms a crease on a sheet of paper, a folder which folds the sheet of paper, and an image former which forms an image on the sheet of paper, and
the information terminal comprises a display which displays a folding setting screen to make a setting on a folding mode of the sheet of paper, wherein
in the information terminal, when an instruction is given by an operator to execute saddle stitch processing for the sheet of paper, the display displays the folding setting screen, and
on the folding setting screen, a setting display to set a number of folding places and a distance between the folding places is presented.

2. The image forming apparatus system according to claim 1, wherein
in the information terminal, when an instruction is given by the operator to execute the saddle stitch processing for sheets of paper including the sheet of paper, the scoring section executes scoring to form a crease on at least one sheet of paper among the sheets of paper instructed to be folded.

3. The image forming apparatus system according to claim 1, wherein:
the information terminal comprises a folding mode decision section which decides on the number of folding places and the distance between the creases based on a number of sheets of the paper for which the saddle stitch processing is instructed; and
the scoring section forms the crease on the sheet of paper based on the number of folding places and the distance between the folding places decided by the folding mode decision section, and the folder folds the sheet of paper.

4. The image forming apparatus system according to claim 3, wherein the folding mode decision section decides on the number of folding places and the distance between the creases also in consideration of a thickness of the sheet of paper for which an instruction is given to execute the saddle stitch processing.

5. The image forming apparatus system according to claim 3, wherein
the number of folding places and the distance between the creases decided by the folding mode decision section is changeable by the operator.

6. An image forming apparatus comprising a scoring section which forms a crease on a sheet of paper, a folder which folds the sheet of paper, and an image former which forms an image on the sheet of paper, in which
the image forming apparatus comprises a display which displays a folding setting screen to make a setting on a folding mode of the sheet of paper, wherein
when an instruction is given by an operator to execute saddle stitch processing for the sheet of paper, the display displays the folding setting screen, and
on the folding setting screen, a setting display to set a number of folding places and a distance between the folding places is presented.
